(19) United States
(12) Patent Application Publication
(10) Pub. No.: US 2016/0182705 A1
(43) Pub. Date: Jun. 23, 2016

(54) ELECTRIC PRODUCT AND METHOD FOR CONTROLLING AN ELECTRIC PRODUCT

(71) Applicant: LG ELECTRONICS INC., Seoul (KR)

(72) Inventors: Inseop LEE, Seoul (KR); Jonghoon SHIM, Seoul (KR)

(21) Appl. No.: 14/974,107

(22) Filed: Dec. 18, 2015

(30) Foreign Application Priority Data
Dec. 18, 2014 (KR) 10-2014-0182988

(51) Int. Cl. H04M 1/725; H04L 12/28

(52) U.S. Cl. CPC H04M 1/72533; H04L 12/2818; H04L 2012/2841

(57) ABSTRACT

An electric product and a method for controlling an electric product are provided. The electric product may include a communication device configured to communicate with an external apparatus including one or more of a mobile terminal, an external server, or another electric product; a detector configured to detect occurrence of an event; a memory, in which information of an action based on one or more of the event received through the communication device and the event detected by the detector may be stored; and a controller configured to determine whether the action is able to be extracted from the memory based on one or more of the event received through the communication device and the event detected by the detector and to extract the action when the action is able to be extracted.

### CROSS-REFERENCE TO RELATED APPLICATION(S)

This application claims priority under 35 U.S.C. §119 and 35 U.S.C. §365 to Korean Patent Application No. 10-2014-0182988, filed in Korea on Dec. 18, 2014, whose entire disclosure is hereby incorporated by reference.

### BACKGROUND

1. Field

An electric product and a method for controlling an electric product are disclosed herein.

2. Background

Generally, electric products, such as a refrigerator, a washing machine, a cleaner, or a cooking device, are apparatuses that perform their own functions by receiving input of a specific command or without the input of the command. Recently, new technology in which the electric products communicate with external apparatuses and share information has been developed.

In Korean Patent Publication No. 2012-0080084, published on Jul. 16, 2012 and which is hereby incorporated by reference, there is disclosed a remote controller for controlling a component. The remote controller may receive information of the component, may display the information, and may input a command for controlling the component.

However, such a remote controller may just receive information from one or each of a plurality of electric products, and then may separately display the information, and may not automatically produce an action, which should be executed by an electric product, based on a status of the electric product, and may not produce an action either, which should be executed by an electric product, based on Information of a plurality of electric products.

### BRIEF DESCRIPTION OF THE DRAWINGS

Embodiments will be described in detail with reference to the following drawings in which like reference numerals refer to like elements, and wherein:

FIG. 1 is a schematic diagram of a network device according to an embodiment;

FIG. 2 is a block diagram of an electric product included in the network device of FIG. 1; and

FIG. 3 is a flowchart of a method for controlling an electric product according to an embodiment.

### DETAILED DESCRIPTION

Reference will now be made in detail to embodiments, examples of which are illustrated in the accompanying drawings.

In the following detailed description of embodiments, reference is made to the accompanying drawings that form a part hereof, and in which is shown by way of illustration embodiments which may be practiced. These embodiments are described in sufficient detail to enable those skilled in the art to practice the embodiments, and it is understood that other embodiments may be utilized and that logical structural, mechanical, electrical, and chemical changes may be made without departing from the scope. To avoid detail not necessary to enable those skilled in the art to practice the embodiment, the description may omit certain information known to those skilled in the art. The following detailed description is, therefore, not to be taken in a limiting sense.

Also, in the description of embodiments, terms such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, the former may be directly “connected,” “coupled,” and “joined” to the latter or “connected”, “coupled”, and “joined” to the latter via another component.

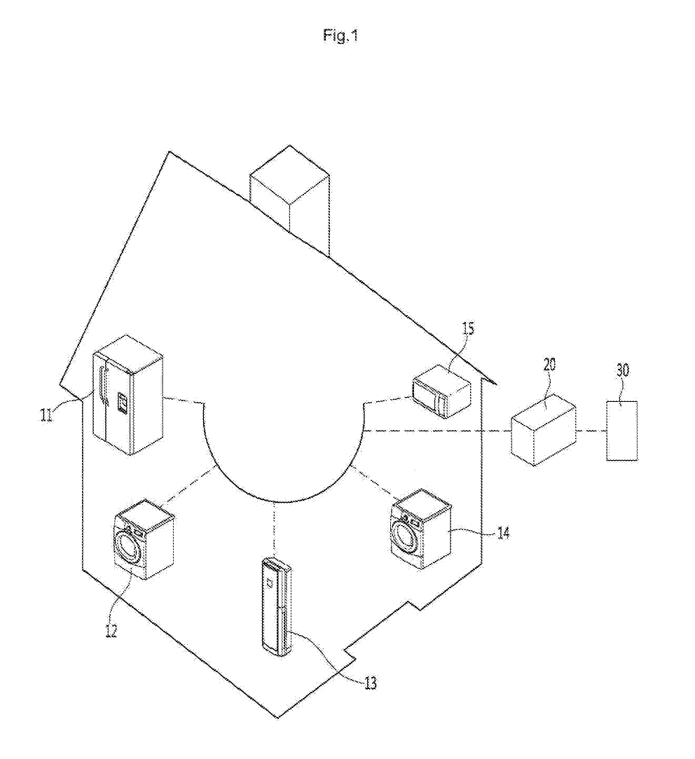

FIG. 1 is a schematic diagram of a network device according to an embodiment. Referring to FIG. 1, a network device according to one embodiment may include a plurality of electric products forming a network, for example, at a home.

For example, the plurality of electric products may include one or more of a refrigerator 11, a washing machine 12, an air conditioner 13, a drying machine or dryer 14, a cooking device 15, a TV, a lighting fixture, a humidifier, a dehumidifier, or an air cleaner, for example. One electric product may communicate with one or more electric products directly or through an external server 20. Also, one or more of the plurality of electric devices may communicate with a mobile terminal 30 directly or through the external server 20. For example, the mobile terminal 30 may be a smart phone. Types of the electric products are not limited to those disclosed herein.

The external server 20 may be a server of a manufacturer of the electric product. One or more of the plurality of electric products may communicate with the external server 20 and a separate web server (not shown). The web server may be a server, which provides weather information, for example. However, embodiments are not limited to a type of web server. Each of the plurality of electric products may be jointed to a network through a network joining process, and the electric products joined to the network may share information with each other.

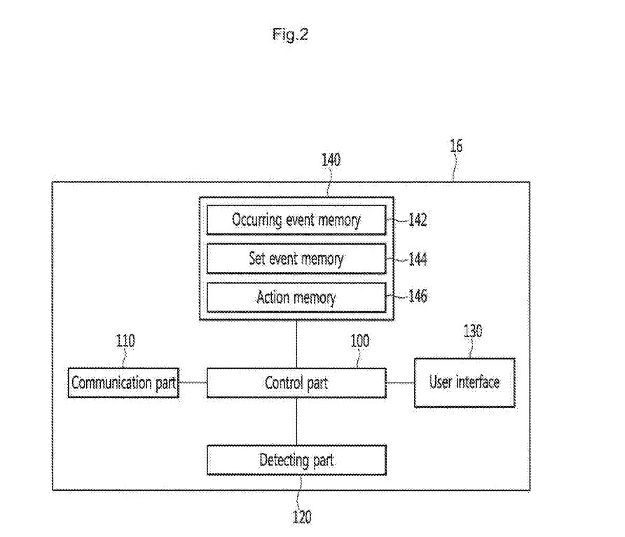

FIG. 2 is a block diagram of an electric product included in the network device of FIG. 1. The configuration of the electric product illustrated in FIG. 2 may be equally applied to all of the electric products.

Referring to FIG. 2, an electric product 16 according to one embodiment may include a communication part or device 110, which may communicate with an external apparatus. A communication method in the communication part 110 may include at least one of Wi-Fi, Zigbee, Bluetooth, or Internet. Embodiments are not limited to the communication method.

The external apparatus, which may communicate with the communication part 110, may include other electric products, the external server 20, the mobile terminal 30, and the web server, for example.

The electric product 16 may include a detecting part or detector 120, which may detect an event. The detecting part 120 may include one or more sensors.

The detecting part 120 may detect a state of each of various components provided in the electric product 16, an overall current state of the electric product 16, or a change in the state of the electric product 16. Alternatively, the detecting part 120 may detect a temperature of each of the various components provided in the electric product 16, or a temperature of a certain space or a fluid provided in the electric product 16. Still alternatively, the detecting part 120 may detect a weight of a certain space or each component in the electric product. Yet alternatively, the detecting part 120 may detect a command or information input from a user interface 130.

Still yet alternatively, the detecting part 120 may detect a temperature, humidity, or intensity of illumination around the electric product 16. Still yet alternatively, the detecting part 120 may detect a power consumption of the entire electric product or each of the various components provided in the electric product 16. Still yet alternatively, the detecting part 120 may detect a voice or a sound. Still yet alternatively, the detecting part 120 may detect a state around the electric product 16.

The detecting part 120 may include one or more timers. The detecting part 120 may detect an elapsed time from a certain point of time.

The electric product 16 may further include the user interface 130. The user interface 130 may include an input part or input, through which a predetermined command may be input, and/or a display part or display, which may display information of the electric product or information received from an outside through the communication part 110.

The electric product 16 may further include a control part or controller 100, which may extract an action which will be executed by the electric product 16. Also, the electric product 16 may include a memory 140, in which a variety of information may be stored.

The memory 140 may store the information of the electric product or the information received from the outside. At this time, the information of the electric product 16 may be information detected by the detecting part 120.

The memory 140 may include an occurring event memory 142, which may store an occurring event, a set event memory 144, which may store a set event (condition), and an action memory 146, which may store the action which will be executed by the electric product 16.

The phase “occurrence of the event” may refer to that the detecting part 120 detects a certain state or information, and that information is received from the external apparatus. Also, the action may be generated when the event occurs or when the occurring event satisfies conditions, and may be a function which should be executed by the corresponding electric product.

The occurring event memory 142 may store an event occurring from the electric product 16 at a current point of time or an event occurring or generated from the external apparatus and received by the electric product 16. The event (hereinafter, referred to as the “occurring event”) occurring from the electric product 16 at the current point of time may vary according to the type of the electric product.

For example, when the electric product 16 is an always-driving or operating product, such as a refrigerator and a water purifier, which may be operated without a user's command, the occurring event may include opening of a refrigerator compartment door or a freezer compartment door, changing of a target temperature of a refrigerator compartment or a freezer compartment (including receiving of a command for changing the target temperature of the refrigerator compartment or the freezer compartment through the user interface 130), changing of a current temperature of the refrigerator compartment or the freezer compartment, changing of a target temperature of the water purifier, changing of a current temperature of water in the water purifier, detecting of an input of food into the electric product, detecting of an expiration date of the food input into the electric product, and/or detecting of a type and an amount of the food input into the electric product, for example. Also, the occurring event may include changing of a state, an amount, and/or a weight, for example, of a source (water, or ice, for example) used or stored in the electric product.

When the electric product 16 is a product, such as a washing machine, a drying machine, a dish washer, a cleaner, and/or a cooking device, for example, which is intermittently operated by a user's operation, the occurring event may include inputting of a start command or automatic starting, inputting of an ending command or ending of an operation, inputting of an operation stopping command or stopping of an operation, and/or inputting of a set command through the user interface, for example. Also, the occurring event may include changing of an operational state or stroke, and changing of a state, an amount, and/or a weight, for example, of a source (water, ice, detergent, fabric softener, or a battery, for example, used or stored in the electric product.

Also, the occurring event may include inputting of a command with respect to a certain state or mode through the user interface 130, regardless of the type of the electric product 16. The certain state or mode may include going-out, on-vacation, power-saving, returning-to-home states, or modes, for example.

Among the occurring events, the event (hereinafter, referred to as a “received event”) occurring or generated from the external apparatus and received by the electric product 16 may include receiving of the above-described occurring event from the external apparatus, receiving of weather, humidity, season, temperature and air volume information, and/or carbon dioxide and yellow sand information, for example, from the external apparatus, receiving of information about the certain state from the external apparatus, and so on.

The set event memory 144 may store a condition by which the action is executed. The condition may be set in advance, or may be manually set or changed by the user. The condition may include a case in which a temperature or humidity reaches a reference value, a case in which a number reaches a reference number, a case in which a state or stroke of the electric product is in a predetermined state, and/or a case in which a state of the source reaches a predetermined state, for example.

The action memory 146 may store an action based on one or more occurring events or received events, an action based on a combination of one or more occurring events and received events, an action based a combination of one or more occurring events or received events and the condition, and/or an action based on a combination of one or more occurring events and received events and the condition. The action may be set in advance or may be manually set or changed by the user.

When information stored in the occurring event memory 142 and information stored in the set event memory 144 coincide with information stored in the action memory 146, the control part 100 may extract the action, which will be executed by the electric product, from the action memory 146. Alternatively, when the information stored in the occurring event memory 142 coincides with the information stored in the action memory 146, the control part 100 may extract the action from the action memory 146. At this time, one or more actions may be extracted.

The electric product 16 may execute the action extracted by the control part 100. Executing of the action may be changing of the state and/or transmitting of the command or information to the external apparatus by the electric product 16. Of course, when the external apparatus receives the command or information from the electric product 16, the external apparatus may execute the corresponding command or may display the corresponding information.

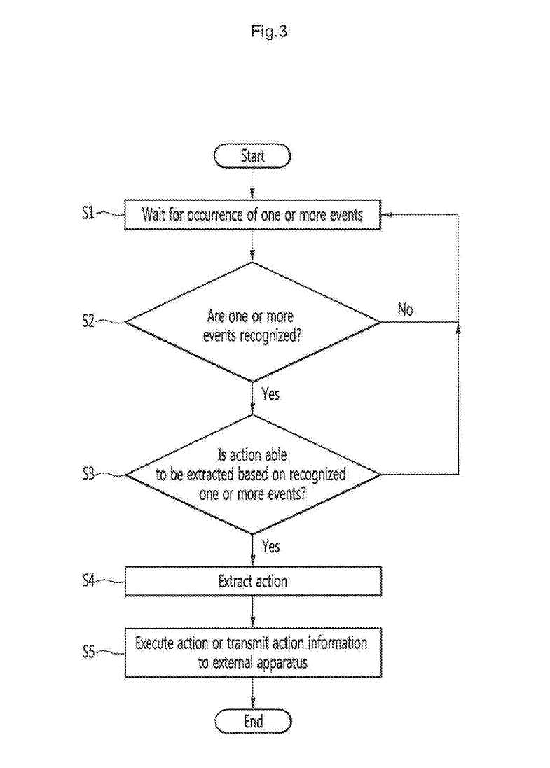

FIG. 3 is a flow chart of a method for controlling an electric product according to an embodiment. Referring to FIG. 3, the electric product 16 may wait for the occurrence of one or more events (S1). Then, the electric product 16 may determine whether the one or more events are recognized (S2).

As a result in operation S2, when the electric product 16 recognizes one or more events, it is determined whether an action may be extracted based on the recognized one or more events (S3). That is, the control part 100 may determine whether the information stored in the occurring event memory 142 and the information stored in the set event memory 144 coincide with the Information stored in the action memory 146, or whether the information stored in the occurring event memory 142 coincides with the information stored in the action memory 146. As a result in operation S3, when the action may be extracted based on the recognized one or more events, the control part 100 may extract one or more actions (S4).

After one or more actions is extracted, the control part 100 may control the electric product 16 to execute the action (S5). That is, the electric product 16 may change the operational state, may display the information or may transmit the command or information to the external apparatus. When the external apparatus is an external server, the external server may transmit the received information to another electric product or the mobile terminal.

Hereinafter, a process in which the action is extracted, and various examples for the execution of the action will be described.

For example, when the electric product is a refrigerator, the occurring event may be opening of a door. In this case, the action may be notifying of door opening information to the external apparatus. That is, an action which notifies the door opening information to the external apparatus when the opening of the door is detected may be stored in the action memory.

In this case, the action may be extracted based on one occurring event. The electric product may transmit action information to the external apparatus. For example, the external apparatus may be the mobile terminal. In this case, the mobile terminal may receive the action, and then may display the action.

As another example, when the electric product is the refrigerator, the occurring event may be the opening of the door. The condition may be a case in which a door opening time reaches a predetermined time, and the action may be the notifying to the external apparatus when the door opening time reaches the predetermined time. In this case, the action may be extracted based one occurring event and one condition.

As still another example, the occurring event may be detecting of the going-out mode. The action may be turning-off of the electric product and transmitting of an OFF command to some or all of the external apparatuses when the going-out mode is detected.

In this case, a plurality of actions may be extracted based on one occurring event. Therefore, when the electric product is being operated, the electric product may be turned off, and the external apparatuses, for example, an air conditioner, TV, and/or a lighting fixture, for example, which receive the action may also be turned off.

As yet another example, the occurring event may be receiving of the on-vacation mode from the external apparatus. The action may be the turning-off of the electric product and the transmitting of the OFF command to some or all of the external apparatuses when the on-vacation mode is received.

As still yet another example, the occurring event may be detecting of returning of the user. The action may be turning-on of the electric product when the returning of the user is detected. For example, when the air conditioner detects the returning of the user, the air conditioner may be turned on. That is, an action in which the air conditioner is turned on may be executed.

As still yet another example, the occurring event may be receiving of the returning-to-home mode of the user from the external apparatus. The action may be turning-on or changing of the state when the returning-to-home mode is received. For example, when a robot cleaner receives the returning-to-home mode, the robot cleaner may automatically perform a cleaning operation, or the refrigerator may start a special freezing operation, or the wash machine or the drying machine may start a washing or drying operation.

As still yet another example, the occurring event may be detecting of a current time. The condition may be a case in which the current time reaches a reference time, and the action may be enabling of the electric product to execute the going-out mode or the returning-to-home mode and transmitting of an execution command of the going-out mode or the returning-to-home mode to the external apparatus when the current time reaches the reference time.

As still yet another example, the occurring event may be detecting of the opening of a refrigerator door. The action may be releasing of the going-out mode in the refrigerator and/or transmitting of a releasing command of the going-out mode to the external apparatus when the opening of the refrigerator door is detected.

As still yet another example, the occurring event may be changing of the target temperature, and the condition may be a case in which the target temperature to be changed is more than or less than a reference temperature. The action may be transmitting of information for notifying a changing state of the target temperature to the external apparatus when the target temperature to be changed is more than or less than the reference temperature.

As still yet another example, the occurring event may be changing of an operational state of the electric product. The action may be notifying of information of a current state to the external apparatus when the operational state is in a predetermined state. For example, when a washing stroke of the washing machine is converted into a drying stroke, state information converted into the drying stroke may be transmitted to the external apparatus.

As still yet another example, the occurring event may be weather information received from the external apparatus, and the condition may be a case in which a current time reaches a reference time. The action may be automatic operating of the electric product, which is in a stopped state when it is sunny and the current time reaches the reference time. For example, in a case in which the electric product is the washing machine, an action in which a washing operation is automatically started when it is sunny and the current time reaches the reference time may be extracted, and the washing machine may execute the extracted action.

As still yet another example, the occurring event may be changing of the expiration date of stored food, and the condition may be a case in which the expiration date of the food reaches a predetermined date. The action may be displaying of a notice that the expiration date has arrived through the electric product when the expiration date of the food reaches the predetermined date.

As still yet another example, the occurring event may be changing of a cooking time, and the condition may be a case in which the cooking time reaches a predetermined time. The action may be displaying of notice information for adding a seasoning or turning the food through the electric product and transmitting of the notice information to the external apparatus when the cooking time reaches the predetermined time.

As still yet another example, the occurring event may be starting of the cooking device, and the action may be automatic operating of the air cleaner when an operation of the cooking device is started. In this case, when the operation of the cooking device is started, the cooking device may transmit a command for operating the air cleaner to the air cleaner.

As still yet another example, the occurring event may be detecting of the input of the food into a certain space, and the action may be reducing of a temperature in the certain space.

As still yet another example, the occurring event may be the receiving of the weather information from the external apparatus, and the condition may be a case in which the current time reaches a reservation time. The action may be transmitting of information for notifying a change in the reservation time to the external apparatus when it is cloudy and the current time reaches the reservation time.

As still yet another example, the occurring event may be detecting of ending of an operation of the electric product. The action may be storing of a date when the operation is ended and operation history information in the memory when the ending of the operation is detected.

As still yet another example, the occurring event may be detecting of a change in a state of the source, and the condition may be a case in which the state of the source is in a reference state. The action may be transmitting of notice information for filling the source to the external apparatus when the state of the source is in the reference state.

As still yet another example, the occurring event may be detecting of a component state in the electric product, and the condition may be a case in which the component is in a state in which the component should be replaced. The action may be displaying of notice information for replacement of the component through the electric product and/or transmitting of the notice information for the replacement of the component to the external apparatus when the component is in the state in which the component should be replaced.

In the above-described embodiments, the electric product determines whether it is possible to extract the action. However, among the external apparatuses, the external server may determine whether it is possible to extract the action.

That is, the external server may receive the occurring event from the electric product or the mobile phone, may determine whether it is possible to extract the action, and then may transmit the extracted action to the electric product or the mobile phone so as to be executed by the electric product or the mobile phone, when it is possible to extract the action.

Embodiments disclosed herein are directed to providing an electric product which is able to generate an action based on one or more events and then to execute the action, or to transmit information of the action to an external apparatus, and a method for controlling the same.

Embodiments disclosed herein provide an electric product that may include a communication part or device configured to be able to communicate with an external apparatus; a detecting part or detector configured to detect occurrence of an event; a memory, in which information of an action based on one or more of the event received through the communication part and the event detected by the detecting part may be stored; and a control part or controller configured to determine whether the action is able to be extracted from the memory based on one or more of the event received through the communication part and the event detected by the detecting part and to extract the action when the action is able to be extracted. The external apparatus may include one or more of a mobile terminal, an external server, or another electric product.

The control part may control the electric product to execute the extracted action. Executing of the extracted action may be changing of a state of the electric product. Executing of the extracted action may be transmitting of a command or state information to the external apparatus.

The memory may include an occurring event memory configured to store one or more of the event received through the communication part and the event detected by the detecting part, a set event memory configured to store information of a condition, and an action memory configured to store the action which will be executed by the electric product. The control part may extract one or more actions stored in the action memory based on one or more events stored in the occurring event memory. The control part may be able to extract a plurality of actions from the action memory.

The control part may extract one or more actions stored in the action memory based on one or more events stored in the occurring event memory and one or more conditions stored in the set event memory. The condition stored in the set event memory may be able to be manually set or changed. The action stored in the action memory may be able to be manually set or changed.

The detecting part may be able to detect a state of various components provided at the electric product, and a current state of the electric product or a change of the state thereof. The detecting part may be able to detect one or more of temperature, humidity, intensity of illumination, a power consumption, a sound, a voice, or a weight. The detecting part may include a timer that detects an elapsed time. The detecting part may detect a command or information input from a user interface.

Embodiments disclosed herein further provide a method for controlling an electric product that may include recognizing occurrence of one or more events by the electric product; determining whether an action which will be executed by the electric product is able to be extracted based on the recognized one or more events; and executing the action by the electric product when the action is able to be extracted. In the recognizing of the occurrence of the one or more events, a detecting part or detector provided at the electric product may detect the occurrence of the events or receive the events occurring from an external apparatus through communication with the external apparatus.

In the determining of whether the action is able to be extracted, whether the action stored in a memory is able to be extracted based on the recognized one or more events may be determined. In the executing of the action, a state of the electric product may be changed, or a command or information may be transmitted to an external apparatus which is able to communicate with the electric product. The external apparatus may include one or more of a mobile terminal, an external server, or another electric product.

Embodiments disclosed herein further provide a method for controlling an electric product that may include transmitting a occurring event to a server by one or more electric products, when the event occurs from one or more of a plurality of electric products; receiving an action from the server by one or more of the plurality of electric products, when the action which will be executed by one or more of the plurality of electric products is able to be extracted based on the event received by the server; and executing the action by the electric products which receive the action from the server.

Even though all elements of embodiments are coupled into one or operated in the combined state, embodiments are not limited to such embodiments. That is, all elements may be selectively combined with each other without departing from the scope. Further, when it is described that one comprises (or includes or has) some elements, it should be understood that it may comprise (or include or have) only those elements, or it may comprise (or include or have) other elements as well as those elements if there is no specific limitation. Unless otherwise specifically defined herein, all terms comprising technical or scientific terms are to be given meanings understood by those skilled in the art. Like terms defined in dictionaries, generally used terms needs to be construed as meaning used in technical contexts and are not construed as ideal or excessively formal meanings unless otherwise clearly defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electric product, comprising:
a communication device configured to communicate with an external apparatus including one or more of a mobile terminal, an external server, or another electric product;
a detector configured to detect an occurrence of an event;
a memory, in which information regarding at least one action based on one or more of an event received through the communication device and the event detected by the detector is stored; and
a controller configured to determine whether the at least one action is able to be extracted from the memory and to extract the at least one action when the action is able to be extracted.

2. The electric product according to claim 1, wherein the controller controls the electric product to execute the extracted at least one action.

3. The electric product according to claim 2, wherein the execution of the extracted at least one action includes changing of a state of the electric product.

4. The electric product according to claim 2, wherein the execution of the extracted at least one action includes transmitting a command or state information to the external apparatus.

5. The electric product according to claim 1, wherein the memory includes an occurring event memory configured to store the one or more of the event received through the communication device and the event detected by the detector, a set event memory configured to store information regarding a condition, and an action memory configured to store the at least one action, which will be executed by the electric product.

6. The electric product according to claim 5, wherein the controller extracts the at least one action stored in the action memory based on the one or more of the event received through the communication device and the event detected by the detector stored in the occurring event memory.

7. The electric product according to claim 6, wherein the controller is configured to extract a plurality of actions from the action memory.

8. The electric product according to claim 5, wherein the controller extracts at least one action stored in the action memory based on the one or more of the event received through the communication device and the event detected by the detector stored in the occurring event memory and one or more conditions stored in the set event memory.

9. The electric product according to claim 8, wherein the controller is configured to extract a plurality of actions from the action memory.

10. The electric product according to claim 5, wherein the condition stored in the set event memory is configured to be manually set or changed.

11. The electric product according to claim 5, wherein the action stored in the action memory is configured to be manually set or changed.

12. The electric product according to claim 1, wherein the detector is configured to detect one or more of a state of various components of the electric product, a current state of the electric product or a change in the state thereof, temperature, humidity, intensity of illumination, power consumption, a sound, a voice, and a weight.

13. The electric product according to claim 1, wherein the detector includes a timer that detects an elapsed time.

14. The electric product according to claim 1, wherein the detector detects a command or information input from a user interface.

15. A method for controlling an electric product, the method comprising:
recognizing occurrence of one or more events by the electric product;
determining, via a controller of the electric product, whether an action, which will be executed by the electric product, is able to be extracted based on the recognized one or more events; and
executing, via the controller, the action by the electric product when the action is able to be extracted.

16. The method according to claim 15, wherein, in the recognizing of the occurrence of the one or more events, a detector provided at the electric product detects the occurrence of the events or receives the events occurring from an external apparatus through communication with the external apparatus.

17. The method according to claim 15, wherein, in the determining of whether the action is able to be extracted, whether the action stored in a memory is able to be extracted based on the recognized one or more events is determined by the controller.

18. The method according to claim 15, wherein, in the executing of the action, a state of the electric product is changed, or a command or information is transmitted to an external apparatus which is in communication with the electric product.

19. The method according to claim 18, wherein the external apparatus includes one or more of a mobile terminal, an external server, or another electric product.

20. A method for controlling one or more electric products, the method comprising:
transmitting an occurring event to a server by one or more electric products of a plurality of electric products, when the event occurs;
receiving an action from the server by the one or more of the plurality of electric products, when the action which will be executed by the one or more of the plurality of electric products is able to be extracted based on the event received by the server; and
executing the action by the one or more electric products which receive the action from the server.

21. A network device, comprising:
a server,
at least one first electric product and a plurality of second electric products, wherein the at least one first electric product and a plurality of second electric products communicate via the server, wherein the at least one electric product includes:
a communication device configured to communicate with the server and the plurality of second electric products;
a detector configured to detect an occurrence of an event;
a memory, in which information regarding at least one action based on one or more of an event received through the communication device from the plurality of second electric products and the event detected by the detector is stored; and
a controller configured to determine whether the at least one action is able to be extracted from the memory and to extract the at least one action when the action is able to be extracted.

22. The network device according to claim 21, further including:
a mobile phone in communication with the at least one first electric product and the plurality of second electric products via the server.
